(19) United States
(12) Patent Application Publication
(10) Pub. No.: US 2009/0019951 A1
(43) Pub. Date: Jan. 22, 2009

(54) Template for measuring antimicrobial activity

(76) Inventor: Edelberto Silva, Bogota (CO)

Correspondence Address: ARENT FOX LLP, 1675 BROADWAY, NEW YORK, NY, 10019, US

(21) Appl. No.: 12/061,477

(22) Filed: Apr. 2, 2008

(30) Foreign Application Priority Data
Apr. 2, 2007 (CO) 07-33340

(51) Int. Cl. G01N 1/00

(52) U.S. Cl. 73/863.21

(57) ABSTRACT

The present invention relates, generally, to a device for measuring antimicrobial activity. The microbiological device has cylinders or wells for dispensing sample dilutions for antimicrobial activity testing through agar diffusion and internal flanges to facilitate handling. These features decrease the cost and increase the efficiency of measuring antimicrobial activity.

### FIELD OF THE INVENTION

The present invention relates to the field of microbiology and devices for measuring antimicrobial activity.

### BACKGROUND OF THE INVENTION

Currently, the most commonly used method of measuring antimicrobial activity recommended by United States Pharmacopeia (USP) is the use of cylinders or peni cylinders. This method diffuses antibiotics from a vertical cylinder made of stainless steel or porcelain through a solidified agar layer in a petri box, until growth of the added microorganism is totally inhibited in a circular area. The circular area is known as the “inhibition zone” and is present around the cylinder that contains the antibiotic dilution.

The cylinders used usually have an outside diameter of 8 mm, an inside diameter of 6 mm and a length of 10 mm. These cylinders, however, must be handled individually which creates a risk of contaminating the culture. Also, these devices require extreme care during setup. In some cases, the test has to be restarted just because of unexpected movements. Furthermore, the time required to set up the test and prepare the material is extensive and costly. In addition to requiring costly sub-processes of scrubbing and sterilization before and after each use, there is also an increase in time required to perform the respective tests. The increase in time also adds to the cost.

A second method for analyzing antimicrobial activity are the sensi-discs, which are disclosed in the British Pharmacopeia, European Pharmacopeia and United States Pharmacopeia. The sensi-discs consist of filter paper discs with a diameter similar to that of the above-mentioned cylinders, which are impregnated with known quantities of antibiotics. These devices must be prepared prior to conducting the tests. The sensi-discs, however, produce the superposition of inhibition halos. The superposition of inhibition halos makes reading the results difficult when the halos are located at less than 15 mm from the edge of the plate or when not distributed equidistantly. Furthermore, with sensi-discs it is impossible to see antimicrobial activity of more than one antibiotic concentration.

### SUMMARY OF THE INVENTION

The present invention comprises a disposable and sterile device, made of plastic or metal materials which consist of cylinders or wells to dispense sample dilutions to test antimicrobial activity through agar diffusion. The invention further comprises internal flanges to facilitate the handling of the template.

The invention is useful for conducting potency tests for antibiotics, antibiograms, immunodiffusion, antagonism tests, efficacy assessment and traces of disinfectants, and the quantitative valuation of antibiotics in scrubbing or cleansing water and area and equipment surfaces.

The invention is a device for analyzing antimicrobial activity, in particular, to conduct potency or strength tests of antibiotics, antibiograms, immunodiffusion, antagonism tests, efficacy assessment and traces of disinfectants, and the quantitative valuation of antibiotics in scrubbing or cleansing water and area and equipment surfaces through the use of a template made of plastic or metal. The template further comprises internal flanges to facilitate its handling during testing, and some cylinders or wells to dispense sample dilutions, which have a diameter between 5.8 and 9.5 mm.

### BRIEF DESCRIPTION OF THE DRAWINGS

FIG. 1 shows a top-down view of the template.

### DESCRIPTION OF THE PREFERRED EMBODIMENTS

The disclosed invention reduces the setup time and preparation of the antimicrobial activity tests, and avoids the superposition of halos because the wells are distributed equidistantly and are fixed on a plate.

The disposable and sterile template shown in the FIGURE includes fixed wells. The template increases the safety of the tests and decreases setup times because it requires less handling of the elements.

Additionally, the device performs a quantitative valuation by diffusion in a gel of antibiotics through the microbiological technique (cylinder plate). This reduces the time required for use and handling of peni cylinders and improves the readings.

Because of the minimum handling required, the invention reduces setup time for the tests and ensures accurate results.

The invention also decreases the likelihood of contaminating the test. Likewise, the template material permits easy adherence to the surface of the agar so that sliding of the device is prevented. In addition, since this device is located on the culture medium surface, it reduces the volume of the medium used during the test.

Specifically, the template reduces the setup time for the potency tests because it is positioned directly onto the medium inoculated with the microorganism in the petri box. Diluted antibiotic are dispensed directly into the wells of the template which guarantees symmetry and diameter of the wells. The wells contain the solution of the antibiotic, thereby preserving the USP recommendations.

Using the template in hospital and clinical laboratories to set up antibiograms allows for more concrete data to be obtained during the test. Because the antibiotic solution added to the wells has an exact concentration, several concentrations of the same drug can be evaluated simultaneously so that the technique is more specific. It is possible to know exactly what concentration is required from the drug to control the growth of the germ causing the infection in the patient. For the antagonism tests, it replaces filter paper impregnated with a suspension of the strains being faced.

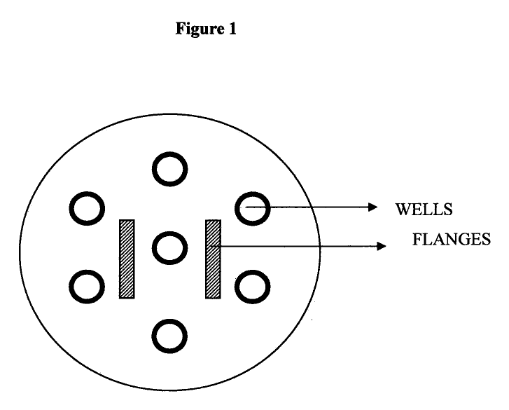

The invention consists of a disposable and sterile template made of stainless steel, ABS polystyrene, crystal polystyrene or polyethylene, consisting of cylinders or wells for dispensing sample dilutions for testing antimicrobial activity through agar diffusion, and internal flanges to facilitate its handling, as can be seen in FIG. 1.

A preferred embodiment of the invention, without limiting its scope, consists of a disposable and sterile template made of crystal polystyrene obtained through the injection process. The microbiological device has between 6 and 15 cylinders or wells for dispensing sample dilutions for antimicrobial activity testing through agar diffusion and between 2 and 4 internal flanges to facilitate handling. The template has the following dimensions: a diameter between 130 and 80.8 mm, plus or minus 0.5 mm; a weight that varies between 236 g and 11.5, plus or minus 0.5 g; body thickness of about 1.9 mm; flange height of about 10.5 mm, plus or minus 0.5 mm; largest cylinder diameter: 9.0 mm, plus or minus 0.5 mm; smallest cylinder diameter: 6.0 mm, plus or minus 0.2 mm.

1. A device for measuring antimicrobial activity, that is sterile and disposable, made of plastic or metal materials, and includes cylinders for dispensing sample dilutions through agar diffusion, and internal flanges for its handling.

2. A device such as in claim 1, in that it comprises between six (6) and fifteen (15) cylinders arranged on the perimeter, and one (1) cylinder arranged in the center, for which the cylinders have a diameter between 5.8 and 9.5 mm.

3. A device as per claim 2, in that it comprises between two (2) and four (4) internal flanges, with a height between 4.5 and 11 mm high.

4. A device as per claim 3, in that it comprises seven (7) cylinders and two (2) internal flanges.

5. A device as per claim 4, in that the construction materials are selected of stainless steel, ABS polystyrene, stainless steel, crystal polystyrene or polyethylene.

6. A device as per claim 4, in that it is made of crystal polystyrene.
